(19) United States
(12) Patent Application Publication
(10) Pub. No.: US 2002/0060083 A1
(43) Pub. Date: May 23, 2002

(54) Grounding device

(76) Inventors: Geoffrey Brook, Calgary (CA); Robert G. J. Jack, DeWinton (CA)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 09/964,196

(22) Filed: Sep. 26, 2001

(30) Foreign Application Priority Data
Nov. 22, 2000 (IE) S2000/0948

(51) Int. Cl. H01B 13/00

(52) U.S. Cl. 174/5 SG

(57) ABSTRACT

A grounding device for attachment to the base of a steel utility pole comprises a length of steel pipe with two lengths of steel angle iron welded across one end of the pipe at an angle to one another.

### FIELD OF THE INVENTION

This invention relates to a grounding device for a steel utility pole.

### BACKGROUND OF THE INVENTION

When steel utility poles are set into the ground, it is often necessary to ground the pole using a special grounding device. This is because simply using the pole itself as its own grounding device will not normally meet official safety regulations, e.g., the U.S. National Electric Safety Code (NESC).

Existing grounding devices tend to be expensive to manufacture and often project above the surface of the ground where they can be damaged and are unsightly.

### SUMMARY OF THE INVENTION

According to the present invention there is provided a grounding device comprising a length of steel pipe with two lengths of steel angle iron welded across one end of the pipe at an angle to one another.

In the embodiment the pipe is substantially circular in cross-section and the two angle irons are welded substantially at right angles to one another so that each extends substantially diametrically across the end of the pipe.

### BRIEF DESCRIPTION OF THE DRAWINGS

An embodiment of the invention will now be described, by way of example, with reference to the accompanying drawings, wherein:

FIG. 1 is a perspective view of a grounding device according to the invention;

FIG. 2 is a cross-section of the device fitted to the base of a steel pole in use; and

FIG. 3 is a perspective view of the device fitted to the base of the steel pole.

### DESCRIPTION OF THE PREFERRED EMBODIMENTS

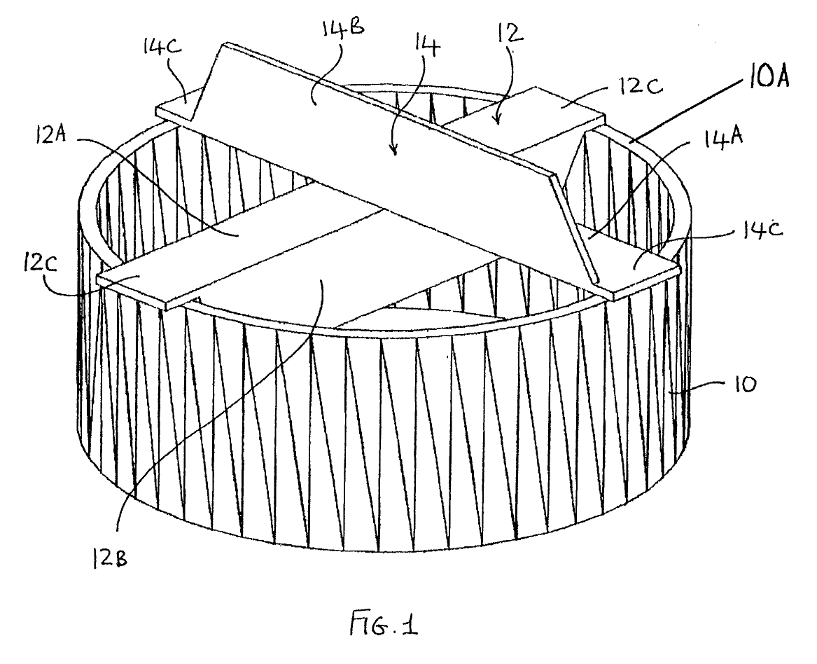

Referring to FIG. 1, a grounding device according to the invention comprises a short length of steel pipe 10 with two lengths of steel angle iron 12, 14 welded across one end of the pipe at an angle to one another. In the present embodiment the pipe 10 is substantially circular in cross-section and the two angle irons 12, 14 are welded substantially at right angles to one another so that each extends diametrically across the end of the pipe.

More specifically, each angle iron 12, 14 has one leg 12A, 14A respectively extending beyond the other leg 12B, 14B at each end of the angle iron so as to provide a pair of tabs 12C, 14C at the opposite ends of the respective angle irons. The angle iron 12 has its tabs 12C welded to the periphery 10A of the pipe 10 with its leg 12B depending into the pipe. The angle iron 14 has its leg 14A extending transversely across the leg 12A of the angle iron 12 with its leg 14B upstanding away from the pipe, the center of the leg 14A being welded to the center of the leg 12A where they cross. This leaves a gap between the tabs 14C and the periphery 10A of the pipe 10 equal to the thickness of the tabs 12C. Preferably the device is galvanized.

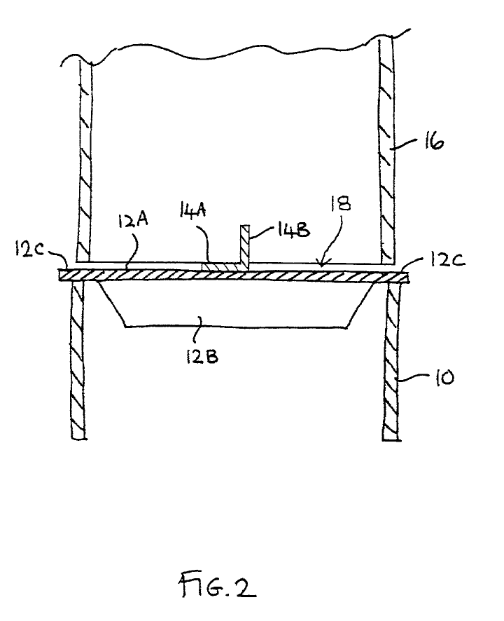

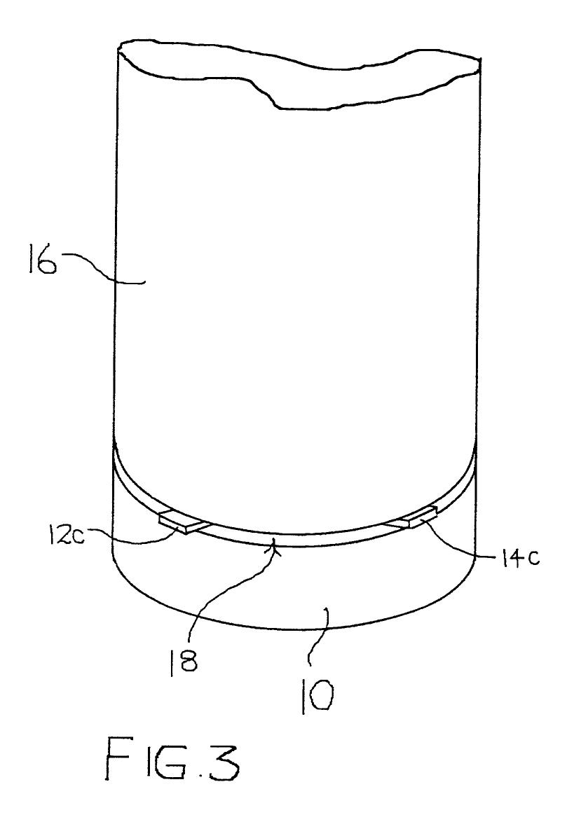

In use, FIGS. 2 and 3, the grounding device is welded to the bottom end of a hollow steel utility pole 16. In particular, the pole 16 is disposed substantially coaxial with the pipe 10 and is welded to the tabs 14C on the opposite side thereof to the pipe 10. This leaves a peripheral gap 18 between the pipe 10 and the pole 16 equal in thickness to the combined thickness of the tabs 12C and 14C.

Advantages of the above grounding device are:

a. It is cheap to make, consisting of lengths of pipe and angle iron cut from commercially available stock.

b. It may be manufactured in a range of sizes to fit different diameters of utility poles, and with pipe and angle irons of such dimensions as to meet the requirements of various safety regulations.

c. It is not significantly wider than the bottom diameter of the utility pole to which it is fixed, and therefore does not need to have a lot of extra soil removed when putting the pole in the ground.

d. It cannot easily be knocked off or removed from the pole if the latter is bumped around, dragged on the ground or struck against other objects.

e. It is not visible when installed, and is therefore more aesthetically pleasing.

f. It is easily galvanized.

g. It allows water to flow through the utility pole into the ground.

h. It requires no maintenance.

The invention is not limited to the embodiment described herein which may be modified or varied without departing from the scope of the invention.

1. A grounding device comprising a length of steel pipe with two lengths of steel angle iron welded across one end of the pipe at an angle to one another.

2. A grounding device as claimed in claim 1 in further combination with a hollow steel pole, wherein the grounding device is welded to one end of the pole.

3. A grounding device as claimed in claim 1, wherein the pipe is substantially circular in cross-section and the two angle irons are welded substantially at right angles to one another so that each extends substantially diametrically across the end of the pipe.

4. A grounding device as claimed in claim 3, in further combination with a hollow steel pole, wherein the grounding device is welded to one end of the pole.

5. A grounding device as claimed in claim 3, wherein each angle iron has one leg extending beyond the other leg at each end of the angle iron so as to provide a pair of tabs, wherein a first angle iron has its tabs welded to the periphery of the pipe with its said other leg depending into the pipe, and wherein the second angle iron has its said one leg extending transversely across and welded to the said one leg of the first angle iron with its said other leg upstanding away from the pipe.

6. A grounding device as claimed in claim 5 in further combination with a hollow steel pole, wherein the grounding device is welded to one end of the pole.

7. A grounding device as claimed in claim 6, wherein the pole is substantially coaxial with the pipe and is welded to the tabs of the second angle iron on the opposite side thereof to the pipe.
